(19) United States
(12) Patent Application Publication
(10) Pub. No.: US 2009/0165515 A1
(43) Pub. Date: Jul. 2, 2009

(54) GRANULAR SLOW-RELEASE NITROGENOUS FERTILIZER

(75) Inventors: Hiroshi Aoki, Fukuoka (JP); Takahiro Watanuki, Fukuoka (JP); Kiyoshi Tsuji, Fukuoka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Mitsubishi Chemical Agri, Inc., Chiyoda-ku (JP)

(21) Appl. No.: 12/334,668

(22) Filed: Dec. 15, 2008

(30) Foreign Application Priority Data
Dec. 28, 2007 (JP) 2007-339506

(51) Int. Cl. C05C 9/02

(52) U.S. Cl. 71/28

(57) ABSTRACT

A granular slow-release nitrogenous fertilizer which is less in the release velocity of a nitrogen component than a conventional granular slow-release nitrogenous fertilizer and which is excellent in long-term persistence and the sustained releasability of the nitrogen component. The granular slow-release nitrogenous fertilizer is prepared by granulating a mixture of a urea-aldehyde condensate and an oxidized wax. The content of the oxidized wax is preferably three to 25 weight percent and more preferably five to 15 weight percent. The oxidized wax contains polar groups and therefore has extremely excellent compatibility with the urea-aldehyde condensate. Therefore, the urea-aldehyde condensate, which is sparingly soluble, is extremely uniformly dispersed in the granular slow-release nitrogenous fertilizer according to the present invention; hence, the release velocity of the urea-aldehyde condensate into soil is low.

### FIELD OF INVENTION

The present invention relates to granular slow-release nitrogenous fertilizers capable of controlling the release velocity of fertilizer components, particularly nitrogen components, into soil. The present invention particularly relates to a granular slow-release nitrogenous fertilizer from which a fertilizer component (nitrogen) is stably released into soil, which requires no coat or the like, and of which granules have a uniform size and different release velocities.

### BACKGROUND OF INVENTION

The cultivation of agricultural crops requires fertilizers depending on the growth stages thereof. In order to cope with their demands, fertilization practices such as base-dressing and top-dressing have been conducted before the harvest of the crops. In recent years, agriculture has been modernized and agricultural population has decreased; hence, it has been necessary to develop fertilizers which are fuss-free and which require only a few fertilization practices. Various fertilizers have been developed such that the release of fertilizer components meets the nutrition demands of crops.

For example, a necessary amount of a readily available nitrogenous fertilizer is applied to a crop several times such that the crop is protected from injury by concentrated nitrogen or the utilization efficiency of the nitrogenous fertilizer is increased. A slow-release nitrogenous fertilizer such as a urea-aldehyde condensate fertilizer represented by a urea-isobutyl aldehyde condensate (isobutylidene diurea hereinafter referred to as “IBDU” in some cases) uses that the urea-aldehyde condensate is gradually decomposed in soil because the solubility of the urea-aldehyde condensate in water is low. The slow-release nitrogenous fertilizer has an advantage that a necessary amount of the slow-release nitrogenous fertilizer can be used in one operation and this allows fertilization to save labor and also has an advantage that eluviation or effusion hardly occurs and therefore the utilization efficiency of crops is high. The dissolution rate of the slow-release nitrogenous fertilizer is proportional to the surface area of granules of the slow-release nitrogenous fertilizer; hence, the granule size of the fertilizer is varied to adjust the specific surface area of the granules, whereby the fertilizer is transformed into a granular slow-release fertilizer having a dissolution rate that meets fertilization conditions.

In recent years, a so-called bulk blend fertilizer, (hereinafter referred to as “BB fertilizer” in some cases) which is prepared by blending fertilizers containing various fertilizer components such as nitrogen, a phosphate, and potassium in advance of fertilization, has been widely used. In order to prevent classification that causes the imbalance of components of the fertilizer, that is, in order to prevent the phenomenon that large granules and small granules of the fertilizer gather at an upper portion and lower portion, respectively, of a storage vessel or a fertilizer applicator, it is important to make the granule size of the fertilizer uniform. In order to cope with the need for labor saving, mechanical fertilization techniques using various fertilizer applicators such as side-dress fertilizer applicators and broadcasters have been widely used. In fertilization practices using such applicators, the granule size of a granular fertilizer that can be handled with a single applicator is limited. In the case where such a fertilization practice is used, a fertilizer principally containing nitrogen needs to have a granule size close to that of a granular fertilizer containing a phosphate component and/or a potassium component other than a nitrogen component.

In conventional granular slow-release fertilizers, particularly granular slow-release nitrogenous fertilizers containing urea-isobutyl aldehyde condensates, there is a problem in that the use thereof is limited because the size of granules thereof is adjusted such that the granules have different release velocities. In BB fertilizers or fertilizes used for mechanical fertilization techniques, granular fertilizers having a narrow granule size distribution and high granule hardness are used as described above. Conventional slow-release nitrogenous fertilizers such as urea-aldehyde condensates have a small granule size and low granule hardness. It is difficult to produce the conventional slow-release nitrogenous fertilizers such that have a relatively large granule size. Therefore, the conventional slow-release nitrogenous fertilizers are problematic as nitrogenous fertilizers used for the BB fertilizers or mechanical fertilization techniques.

On the other hand, the present applicant has focused on that the surface area of granules of a slow-release nitrogenous fertilizer having low solubility in water closely correlates with the rate of a nitrogen component released into soil, has then found that the release velocity of the nitrogen component can be controlled in such a manner that the surface area of the granules is adjusted by making inner portions of the granules porous, and has proposed a granular slow-release nitrogenous fertilizer which contains a continuous phase containing a urea-aldehyde condensate and a disperse phase containing a water-soluble substance at a weight ratio of 95:5 to 50:50 (Patent Document 1).

In the granular slow-release nitrogenous fertilizer of Patent Document 1, the release velocity of a nitrogen component can be adjusted in an extremely wide range without varying the granule size thereof because of the presence of the disperse phase, which contains the water-soluble substance, in the continuous phase, which contains the urea-aldehyde condensate.

[Patent Document 1] Japanese Unexamined Patent Application Publication No. 2005-35828 published on Feb. 10, 2005 in Japan

The granular slow-release nitrogenous fertilizer disclosed in Patent Document 1 tends to be greater in the release velocity of a nitrogen component as compared to a fertilizer which does not contain any disperse phase containing a water-soluble substance but contains only a urea-aldehyde condensate because of the presence of the disperse phase containing the water-soluble substance. On the other hand, the following fertilizer is being demanded: a granular slow-release nitrogenous fertilizer which has a release velocity less than that of a conventional fertilizer containing only a urea-aldehyde condensate and in which the sustained releasability of a nitrogen component and long-term persistence are high.

### SUMMARY OF INVENTION

Accordingly, it is an object of the present invention to provide a granular slow-release nitrogenous fertilizer which is less in the release velocity of a nitrogen component than a conventional granular slow-release nitrogenous fertilizer and which is excellent in the sustained releasability of the nitrogen component and long-term persistence.

In order to solve the above problems, the inventors have performed intensive investigation. As a result, the inventors have found that a granular slow-release nitrogenous fertilizer in which the release velocity of a urea-aldehyde condensate is small and which is excellent in the sustained releasability of a nitrogen component and long-term persistence can be obtained in such a manner that the urea-aldehyde condensate is mixed with oxidized wax and the mixture is granulated. This has resulted in the completion of the present invention. The present invention is as summarized below.

[1] A granular slow-release nitrogenous fertilizer prepared by granulating a mixture of a urea-aldehyde condensate and an oxidized wax.
[2] In the granular slow-release nitrogenous fertilizer specified in Item [1], the content of the oxidized wax is three to 25 weight percent.
[3] In the granular slow-release nitrogenous fertilizer specified in Item [2], the content of the oxidized wax is five to 15 weight percent.
[4] In the granular slow-release nitrogenous fertilizer specified in any one of Items [1] to [3], the oxidized wax satisfies the following requirements:

(i) an acid value of 3 to 25 mg-KOH/g and

(ii) a saponification value of 10 to 70 mg-KOH/g.

[5] In the granular slow-release nitrogenous fertilizer specified in any one of Items [1] to [4], the urea-aldehyde condensate contains 70 weight percent or more of sub-condensates having the same degree of condensation.
[6] In the granular slow-release nitrogenous fertilizer specified in any one of Items [1] to [5], the urea-aldehyde condensate is a urea-isobutylaldehyde condensate.

Since the granular slow-release nitrogen fertilizer according to the present invention contains the oxidized wax, the granular slow-release nitrogen fertilizer is less in the release velocity of the urea-aldehyde condensate than a conventional granular slow-release nitrogenous fertilizer and is excellent in long-term persistence and the sustained releasability of a nitrogen component.

In the present invention, the mechanism of increases in slow-release properties due to mixing the oxidized wax with the urea-aldehyde condensate is unclear in detail; however, the mechanism is probably as described below. The oxidized wax contains polar groups and therefore has extremely excellent compatibility with the urea-aldehyde condensate. Therefore, the urea-aldehyde condensate, which is sparingly soluble, is extremely uniformly dispersed in the granular slow-release nitrogenous fertilizer according to the present invention; hence, the release velocity of the urea-aldehyde condensate into soil is low.

### BRIEF DESCRIPTION OF DRAWINGS

FIG. 1 is a graph showing the underwater release patterns of granular fertilizers produced in Examples 1 to 3 and Comparative Examples 1 and 2.

FIG. 2 is a graph showing the underwater release patterns of granular fertilizers produced in Examples 1 and 4 to 6 and Comparative Example 1.

### PREFERRED EMBODIMENTS

A granular slow-release nitrogenous fertilizer according to the present invention will now be described in detail.

### [Urea-Aldehyde Condensate]

A urea-aldehyde condensate used herein is described below.

The urea-aldehyde condensate according to the present invention is obtained by the dehydrocondensation of urea and an aldehyde and a method for producing the urea-aldehyde condensate is arbitrary. The aldehyde subjected to the dehydrocondensation may be arbitrary. Examples of the aldehyde include isobutylaldehyde, crotonaldehyde, acetoaldehyde, and formaldehyde. These aldehydes may be used alone or in combination. The form of the urea subjected to the reaction is arbitrary and may be solid, liquid (melt), or the like.

Examples of the urea-aldehyde condensate used herein include urea-isobutylaldehyde condensates (IBDUs), urea-formaldehyde condensates (ureaforms hereinafter referred to as “UFs” in some cases), and urea-crotonaldehyde condensates (crotonylidene diurea hereinafter referred to as “CDU” in some cases). The UFs can be adjusted in release velocity without using such a technique that the degree of condensation thereof is adjusted, the technique being industrially difficult. In the present invention, when the urea-aldehyde condensate, which is obtained by the condensation of urea and the aldehyde, contains urea-aldehyde sub-condensates having a plurality of degrees of condensation, the content of the urea-aldehyde sub-condensates having the same degree of condensation in the urea-aldehyde condensate is preferably 70 weight percent or more, more preferably 80 weight percent or more, and further more preferably 90 weight percent or more because the release curve of the slow-release nitrogenous fertilizer is stable. In particular, an IBDU or CDU is preferably used because the IBDU or CDU is more effective in readily obtaining a condensate containing 70 weight percent or more of sub-condensates having the same degree of condensation as compared to a UF that contains about 50 weight percent of sub-condensates having the same degree of condensation since various condensates are produced in the course of producing the UF.

The urea-aldehyde condensate is used in the form of powder and usually has granule size of 1 mm or less, preferably 0.7 mm or less, and more preferably 0.5 mm.

### [Oxidized Wax]

The oxidized wax, which is used in combination with the urea-aldehyde condensate, is described below.

The oxidized wax used herein is one prepared by introducing a polar group such as a carboxyl group, an ester group, or a hydroxyl group into an aliphatic hydrocarbon such as an olefin or paraffin that is semi-solid or solid at room temperature. The oxidized wax is commercially available.

The number of polar groups in the oxidized wax can be expressed with an acid value, a saponification value, or a hydroxyl value. The oxidized wax used herein preferably has the polar groups such that Requirements (i) and/or (ii) below are satisfied.

(i) An acid value of 3 to 25 mg-KOH/g and preferably 5 to 20 mg-KOH/g

(ii) A saponification value of 10 to 70 mg-KOH/g and preferably 20 to 50 mg-KOH/g

Properties of commercially available oxidized waxes (produced by Nippon Seiro Co., Ltd.) usable herein are as described below. The oxidized wax according to the present invention is limited to none of these waxes.

TABLE 1

| | | | Saponification |
|---|---|---|---|
| | Melting point | Acid value | value |
| Products | (° C.) | (mg-KOH/g) | (mg-KOH/g) |
| NPS-9210 | 75 | 12 | 30 |
| NPS-9125 | 63 | 28 | 75 |
| OX-1949 | 83 | 14 | 38 |
| NPS-6115 | 77 | 11 | 105 |
| NPS-6010 | 75 | 11 | 40 |
| HAD-5090 | 75 | 5 | 22 |
| HAD-5105 | 101 | 3 | 19 |

These waxes may be used alone or in combination.

In view of handling during granulation and in view of the compatibility with the urea-aldehyde condensate, the oxidized wax is used in the form of particles with a size of 0.5 mm or less and more preferably 0.25 mm or less.

When the content of the oxidized wax in the granular slow-release nitrogenous fertilizer according to the present invention is excessively small, the effect of enhancing slow-release properties thereof by the use of the oxidized wax cannot be sufficiently achieved. Therefore, the content of the oxidized wax in the granular slow-release nitrogenous fertilizer according to the present invention is preferably three weight percent or more and more preferably five weight percent or more. However, an excessive increase in the content of the oxidized wax leads to a decrease in the content of the urea-aldehyde condensate. This causes a reduction in the efficacy of the fertilizer and/or causes an excessive amount of the oxidized wax to seep out of granules. Therefore, the content of the oxidized wax is preferably 25 weight percent or less and more preferably 15 weight percent or less.

### [Production Method]

The granular slow-release nitrogenous fertilizer according to the present invention can be produced in such a manner that the urea-aldehyde condensate and the oxidized wax are mixed together at a predetermined ratio and the mixture is granulated. A granulating liquid may be used for granulation. Examples of the granulating liquid include water, aqueous solutions of water-soluble substances, methylol urea solutions, and aqueous dispersions of the urea-aldehyde condensate. The use of a methylol urea solution or a urea-aldehyde condensate suspension as a granulating liquid is preferred in securing effective fertilizer components, because the urea-aldehyde condensate is obtained from a dry substance originating from the granulating liquid. In particular, the use of the methylol urea solution is preferred in achieving properties suitable for BB fertilizers or mechanical fertilization techniques, because methylation occurs during drying subsequent to granulation and therefore formed granules have extremely high hardness.

In the case where the granulating liquid is used to the granulate the urea-aldehyde condensate and the oxidized wax, the content of the urea-aldehyde condensate in the granular slow-release nitrogenous fertilizer is preferably 75 weight percent or more and more preferably 85 to 95 weight percent, because effective fertilizer components are secured.

A granulator used to produce the granular slow-release nitrogenous fertilizer according to the present invention may be appropriately selected from those used in known techniques for producing granular fertilizers. Examples of the granulator include dish and drum granulators including rotary granulation vessels and stirring (mixing) granulators including granulation vessels containing high-speed rotary blades. The urea-aldehyde condensate, which is a principal raw material used herein, has lower density and higher water-repellency as compared to ordinary chemical fertilizers and therefore is inferior in granulation properties. Therefore, a stirring (mixing) granulator which is one of the above granulators is preferably used because of its high granulating ability (high compression stress applied to granules).

In a method for producing the granular slow-release nitrogenous fertilizer according to the present invention, such a granulator is used; particles serving as nuclei of the granular slow-release nitrogenous fertilizer are tumbled in the granulator; the granulating liquid, the urea-aldehyde condensate, and the oxidized wax are continuously added to the particles in turn or simultaneously; and the particles may be grown (granulated) into granules having a necessary size. The size of the granules may be adjusted by the amount of the added granulating liquid, the addition rate of the granulating liquid, mechanical conditions of the granulator, and/or a known technique such as the appropriate adjustment of granulation time or the like.

Alternatively, the following process may be used: a process in which a powder of the urea-aldehyde condensate and a powder of the oxidized wax are mixed together in advance and the mixture is granulated or a process in which these powders are separately added to the particles. In consideration of the dispersion of the oxidized wax in the granular slow-release nitrogenous fertilizer according to the present invention, these powders are preferably simultaneously added to the particles. A technique for adding the granulating liquid is arbitrary. The granulating liquid is preferably added uniformly to a region where the particles are sufficiently tumbled, because the yield of product granules is increased. If small granules with a size less than a desired size are obtained, the small granules are preferably used as nuclei of the granular slow-release nitrogenous fertilizer in a next granulating operation.

After granulation, the obtained granular slow-release nitrogenous fertilizer may be dried as required. The drying temperature thereof is preferably within a range where the urea-aldehyde condensate or oxidized wax in the granular slow-release nitrogenous fertilizer is not decomposed. In particular, the drying temperature thereof is preferably room temperature to 120° C., more preferably 40° C. to 120° C., and further more preferably 60° C. to 100° C. In the case where an aqueous solution of methylol urea is used to prepare the granulating liquid for granulation, the granular slow-release nitrogenous fertilizer is preferably dried within a range from 60° C. to 120° C. and more preferably 80° C. to 100° C., because the methylol urea used induces methylenation by the action of an acid catalyst and functions as a urea resin adhesive for maintaining physical properties.

The granule size of the granular slow-release nitrogenous fertilizer according to the present invention is arbitrary and may be appropriately adjusted depending on purposes thereof. The granule size thereof is usually 0.5 to 15 mm, preferably 1 to 10 mm, and more preferably 2 to 6 mm. If the granular slow-release nitrogenous fertilizer is used for BB fertilizers or mechanical fertilization, the granular slow-release nitrogenous fertilizer preferably has a granule size of 2 to 4 mm. The shape of the granular slow-release nitrogenous fertilizer according to the present invention is arbitrary. The granules of the granular slow-release nitrogenous fertilizer preferably have high sphericity, because the granular slow-release nitrogenous fertilizer can be readily handled when being used for such bulk blend fertilizers or mechanical fertilization.

The obtained granular slow-release nitrogenous fertilizer according to the present invention has a structure in which the urea-aldehyde condensate and the oxidized wax are in a uniformly mixed, highly dispersed state. After the granular slow-release nitrogenous fertilizer is applied to soil, the urea-aldehyde condensate is released into water in the soil. The release velocity of the urea-aldehyde condensate is low because of its high dispersibility. The granules are different in release velocity from each other depending on the content of the oxidized wax although the granules have the same size. The granular slow-release nitrogenous fertilizer has a release velocity lower than that of conventional fertilizers.

Applications of the granular slow-release nitrogenous fertilizer according to the present invention are not particularly limited and are appropriately selected depending on nutritional requirements of crops. The granular slow-release nitrogenous fertilizer can be used to supply a nitrogenous nutrient to a relatively long-term cultivation system (the cultivation of wet rice by non-split fertilizer application; the cultivation of fruit vegetables such as tomato, eggplant, and strawberry; or the like) to which granules (a size of 2 to 4 mm) containing only a conventional urea-aldehyde condensate cannot be applied because the effective period of the granules is too short. This leads to the expansion of applications of slow-release nitrogenous fertilizers.

The granular slow-release nitrogenous fertilizer according to the present invention may be used in the form of a bulk blend fertilizer prepared by blending the granular slow-release nitrogenous fertilizer with other fertilizer granules containing fertilizer components. The fertilizer granules used may be of a known type. Examples of the fertilizer granules include granules of straight fertilizers such as ammonium sulfate, ammonium chloride, ammonium nitrate, lime-nitrogen, lime superphosphate, triple superphosphate, multi-phosphate, potassium chloride, and potassium sulfate; granules of ammonium phosphate and chemical fertilizer containing two or more of N, P₂O₅, K₂O, and the like; granules of bulk blend fertilizers prepared by blending two or more of these components.

### EXAMPLES

The present invention is further described below in detail with reference to examples. The present invention is not limited to the examples without departing from the scope thereof.

### [Production of Granular Slow-Release Nitrogenous Fertilizers]

### Example 1

The following materials were prepared and then weighed as shown in Table 2: small-size IBDU particles (a size of 0.7 to 2.5 mm) serving as nuclei, an IBDU powder (a particle size of 0.5 mm or less) serving as a coating powder, and a oxidized wax powder (“NPS-9210”, produced by Nippon Seiro Co., Ltd., having a particle size of 0.25 mm or less) serving as a coating powder.

To 365.5 g of desalted water, 394.8 g of urea and 9.9 g of borax were added. These materials were heated to 50° C. To these materials, 229.7 g of paraformaldehyde (a concentration of 86%) was added. The mixture was stirred for 60 minutes, whereby an aqueous solution of methylol urea was prepared. In immediate advance of granulation, 19.4 g of 50% citric acid solution acting as a methylenation catalyst was added to 1000 g of the aqueous methylol urea solution, whereby a granulating liquid was prepared.

Into a stirring granulator (NG-350, manufactured by Daiwa Kakoki), 780 g of the small-size IBDU particles were charged. The small-size IBDU particles were stirred in such a manner that stirring blades were rotated at a speed of 300±50 rpm. The granulating liquid and a mixture of IBDU powder and the oxidized wax powder were gradually added to the stirred small-size IBDU particles, the amount of each of the granulating liquid, the IBDU powder, and the oxidized wax powder being shown in Table 2. A granulation operation was conducted for ten minutes. An obtained granular product was sieved, whereby granules with a size of 2.36 to 4 mm were obtained. The granules were dried at 100° C. for one hour.

### Examples 2 and 3

In Example 2, a granular fertilizer was produced in substantially the same manner as that described in Example 1 except that an oxidized wax powder (“NPS-6010”, produced by Nippon Seiro Co., Ltd., having a particle size of 0.25 mm or less) was used, the amount of the oxidized wax powder used being shown in Table 2. In Example 3, a granular fertilizer was produced in substantially the same manner as that described in Example 1 except that an oxidized wax powder (“NPS-9125”, produced by Nippon Seiro Co., Ltd., having a particle size of 0.25 mm or less) was used, the amount of this oxidized wax powder used being shown in Table 2.

### Examples 4, 5, and 6

Granular fertilizers were produced in substantially the same manner as that described in Example 1 except that the ratio of an IBDU powder (a particle size of 0.5 mm or less) to the oxidized wax powder (“NPS-9210”, produced by Nippon Seiro Co., Ltd., having a particle size of 0.25 mm or less) was varied as shown in Table 2.

### Comparative Example 1

A granular fertilizer was produced in substantially the same manner as that described in Example 1 except that no oxidized wax was used and amounts of materials shown in Table 2 were used.

### Comparative Example 2

A granular fertilizer was produced in substantially the same manner as that described in Example 1 except that a polar group-free wax ((“LUVAX-1266”, produced by Nippon Seiro Co., Ltd., having a particle size of 0.25 mm or less) was used instead of the oxidized wax and amounts of materials shown in Table 2 were used.

Properties of the oxidized waxes used in Examples 1 to 6 and Comparative Example 1 are shown in Table 3.

Properties of granular products obtained in Examples 1 to 6 and Comparative Examples 1 and 2 are shown in Table 4.

TABLE 2
Specific consumptions for granules (unit: kg)

| | Small-size IBDU | | | | Aqueous |
|---|---|---|---|---|---|
| | particles for | IBDU | | Amount of | methylol |
| | nuclei | powder | Waxes | added waxes | urea solution |
| Example 1 | 0.80 | 2.78 | NPS-9210 | 0.42 | 0.54 |
| Example 2 | 0.80 | 2.78 | NPS-6010 | 0.42 | 0.54 |
| Example 3 | 0.80 | 2.78 | NPS-9125 | 0.42 | 0.54 |
| Example 4 | 0.80 | 2.99 | NPS-9210 | 0.21 | 0.54 |
| Example 5 | 0.80 | 2.57 | NPS-9210 | 0.63 | 0.54 |
| Example 6 | 0.80 | 2.36 | NPS-9210 | 0.84 | 0.54 |
| Comparative | 0.80 | 3.20 | Not used | 0 | 0.54 |
| Example t | | | | | |
| Comparative | 0.80 | 2.78 | LUVAX-1266 | 0.42 | 0.54 |
| Example 2 | | | | | |

TABLE 3
Properties of waxes used for granulation and evaluation

| | | | Saponification |
|---|---|---|---|
| | Melting point | Acid value | value |
| Products | (° C.) | (mg-KOH/g) | (mg-KOH/g) |
| NPS-9210 | 75 | 12 | 30 |
| NPS-6010 | 75 | 11 | 40 |
| NPS-9125 | 63 | 28 | 75 |
| LUVAX-1266 | 69 | 0 | 0 |

TABLE 4
Waxes and content of waxes in granules

| | | Amount of | Weight of | |
|---|---|---|---|---|
| | | added waxes | granules | Wax content |
| | Waxes | (kg) | (kg) | (% by weight) |
| Example 1 | NPS-9210 | 0.42 | 4.2 | 10 |
| Example 2 | NPS-6010 | 0.42 | 4.2 | 10 |
| Example 3 | NPS-9125 | 0.42 | 4.2 | 10 |
| Example 4 | NPS-9210 | 0.21 | 4.2 | 5 |
| Example 5 | NPS-9210 | 0.63 | 4.2 | 15 |
| Example 6 | NPS-9210 | 0.84 | 4.2 | 20 |
| Comparative | Not used | 0 | 4.2 | 0 |
| Example 1 | | | | |
| Comparative | LUVAX-1266 | 0.42 | 4.2 | 10 |
| Example 2 | | | | |

### [Underwater Release Test]

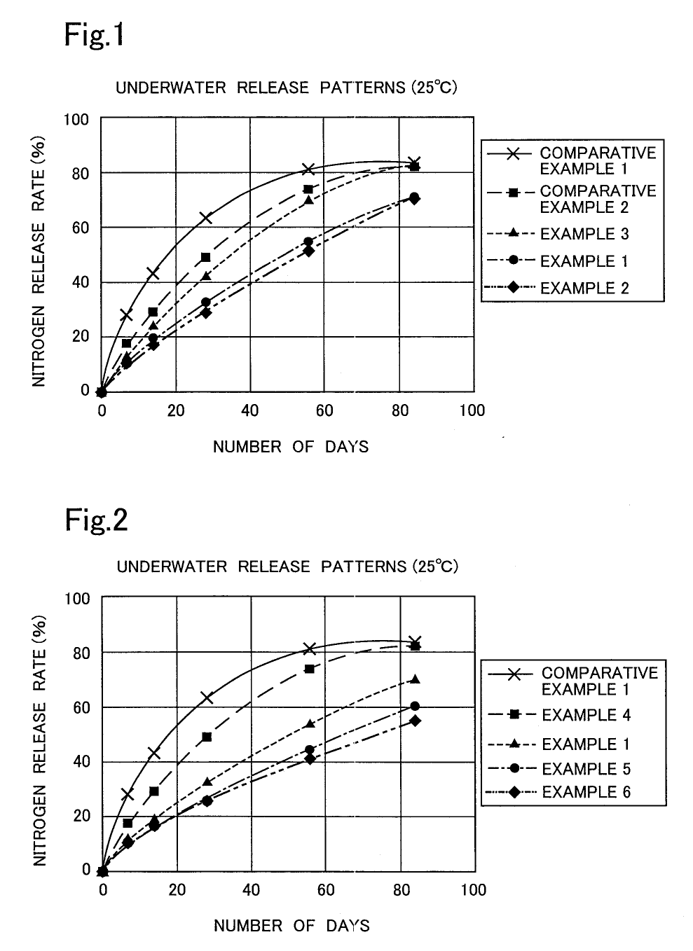

The granular products obtained in Examples 1 to 6 and Comparative Examples 1 and 2 were subjected to an underwater release test. The test results were shown in FIGS. 1 and 2.

The following materials were mixed together: 200 mg of each produced granular slow-release nitrogenous fertilizer and 20 g of sea sand (15-20 mesh). The mixture was packed in a bag of nonwoven fabric, whereby a release package was prepared. Into a 200-ml styrol container, 200 ml of desalted water and the release package were placed. The container was covered and then placed into a 25° C. constant-temperature vessel. After a predetermined time elapsed, the inside of the container was gently swirled and the content of nitrogen in a release solution was measured. The release rate of nitrogen was calculated from the nitrogen content of the release solution and the amount of nitrogen loaded in the release package. The residual release solution was disposed of. Into the container, 200 ml of desalted water was newly poured. The container was placed into the 25° C. constant-temperature vessel again. This procedure was repeated until the accumulated release rate exceeded 80%.

FIG. 1 illustrates that the use of the waxes during the granulation of the urea-aldehyde condensate (IBDU) is effective in suppressing the release of a nitrogen component. In Examples 1 to 3 in which the oxidized waxes were used, this effect is high. In particular, in Examples 1 and 2 (NPS-9210 and NPS-6010, respectively), this effect is remarkably high. This is probably because the presence of an appropriate number of polar groups allows the oxidized waxes to be well dispersed in the IBDU granules. On the other hand, in Comparative Example 2 (LUVAX-1226) in which no polar group is present, the dispersion of an olefin is poor and therefore the release suppression effect is low. In Example 3 (NPS-9215) in which the number of the polar groups is extremely large, the suppression effect is slightly low. This is probably because the oxidized wax used has insufficient water repellency and moisture resistance due to an excessive number of the polar groups.

FIG. 2 illustrates that the addition of five weight percent of the oxidized wax exhibits the release suppression effect and an increase in the amount of the oxidized wax used enhances the release suppression effect; however, the addition of 20 weight percent of the oxidized wax does not exhibit a remarkable increase in the release suppression effect. In Example 6 in which the content of the oxidized wax was 20 weight percent, the oxidized wax was melted during drying and therefore seeped out of the granules. This suggests that the content of the oxidized wax is close to a limit.

The present invention is as described above with reference to the specific embodiments. It is apparent for those skilled in the art that various modifications can be made without departing from the spirit and scope of the present invention.

The present application is based on Japanese Patent Application (No. 2007-339506) filed Dec. 28, 2007 and is incorporated herein by reference in its entirety.

What is claimed is:

1. A granular slow-release nitrogenous fertilizer prepared by granulating a mixture of a urea-aldehyde condensate and an oxidized wax.

2. The granular slow-release nitrogenous fertilizer according to claim 1, wherein the content of the oxidized wax is three to 25 weight percent.

3. The granular slow-release nitrogenous fertilizer according to claim 1, wherein the content of the oxidized wax is five to 15 weight percent.

4. The granular slow-release nitrogenous fertilizer according to claim 1, wherein the oxidized wax has an acid value of 3 to 25 mg-KOH/g.

5. The granular slow-release nitrogenous fertilizer according to claim 1, wherein the oxidized wax has a saponification value of 10 to 70 mg-KOH/g.

6. The granular slow-release nitrogenous fertilizer according to claim 4, wherein the oxidized wax has a saponification value of 10 to 70 mg-KOH/g.

7. The granular slow-release nitrogenous fertilizer according to claim 1, wherein the urea-aldehyde condensate contains 70 weight percent or more of sub-condensates having the same degree of condensation.

8. The granular slow-release nitrogenous fertilizer according to claim 1, wherein the urea-aldehyde condensate is a urea-isobutylaldehyde condensate.

9. The granular slow-release nitrogenous fertilizer according to claim 1, having a granule size of 0.5 to 15 mm.
